(19) United States
(12) Patent Application Publication
(10) Pub. No.: US 2012/0050360 A1
(43) Pub. Date: Mar. 1, 2012

(54) INKJET PRINTER

(75) Inventor: Mitsutoshi Nagamura, Tokyo (JP)

(73) Assignee: CANON KABUSHIKI KAISHA, Tokyo (JP)

(21) Appl. No.: 13/215,564

(22) Filed: Aug. 23, 2011

(30) Foreign Application Priority Data
Aug. 25, 2010 (JP) 2010-188431
Jul. 26, 2011 (JP) 2011-163162

(51) Int. Cl. B41J 2/195

(52) U.S. Cl. 347/7

(57) ABSTRACT

An inkjet printer is provided that is capable of obtaining an image having little color unevenness. The printer has a dot counting unit that counts the number of dots of each color of ink of a plurality of colors of ink to be printed in image data that is to be printed in a processed area that can be printed in scanning by a printing head, and a setting unit that sets an amount of processing liquid to be applied to the processed area based on the number of dots of each color of ink that was counted by the dot counting unit.

### BACKGROUND OF THE INVENTION

1. Field of the Invention

The present invention relates to an inkjet printer that forms an image by ejecting a printing liquid such as ink onto a printing medium while scanning with a printing head.

2. Description of the Related Art

Typically, an inkjet type of printer comprises a carriage in which a printing head is mounted, a conveying unit that conveys a printing medium and a controller for controlling these. Moreover, together with causing the printing head, which ejects ink drops from a plurality of nozzles, to perform serial scanning in a direction (main scanning direction) that is orthogonal to the conveying direction (sub scanning direction) of printing paper, intermittently conveys the printing medium an amount equal to the printing width when not printing. When a printer such as described above prints a color image, printing heads, which eject black ink, cyan ink, magenta ink and yellow ink, for example, that are arranged in the main scanning direction can be used. When using such a printer, all of the colors of ink are ejected during one scan according to image data. Moreover, when forming an image by repeating bi-directional printing of alternating main scanning in the forward direction and main scanning in the backward direction; for example, when forming so-called secondary colors such as blue, red and green, the printing order of ink differs in the forward scan and the backward scan. Also depending on the type of printing medium, there is a tendency for ink that is printed first to stop at the surface layer of the printing medium, and ink that is printed later to permeate into the printing medium. Therefore, for example, when forming a blue image, and magenta is printed after printing cyan, the cyan exists on the surface layer of the printing medium, so that the blue looks more from cyan. However, when cyan is printed after printing magenta, the blue looks more from magenta. When the printing order of ink differs in main scanning in the forward direction and main scanning in the backward direction in this way, there is a possibility that the hue in each main scan will differ and that uneven color will occur, causing a decrease in the image quality.

Japanese Patent Laid-open No. 2001-138554 discloses technology that comprises a processing liquid that causes the coloring material in ink to become insoluble, and controls the amount of processing liquid ejected according to the type of ink and the ejection order of ink. More specifically, color unevenness that is caused by different printing order of ink is reduced by controlling the amount of processing liquid applied. However, in the technology disclosed in that publication, the case in which, depending on the hue of the image printed, the amount of processing liquid is insufficient or excessive is presumed, so that there is a possibility that the effect of improving the image cannot be sufficiently obtained.

### SUMMARY OF THE INVENTION

The present invention provides a printer, an image processing apparatus and an image processing method that are capable of obtaining a high-quality image that corresponds to the hue of the image to be printed.

The present invention provides an image processing apparatus that generates printing data for printing an image in a unit area on a printing medium by causing a printing unit to scan the printing medium, the printing unit being capable of ejecting a plurality of colors of ink and a processing liquid, the processing liquid reacting with the ink, includes:

an acquisition unit that acquires the total number of ink droplets of the plurality of colors of ink to be applied to the unit area and a ratio between the numbers of ink droplets of the plurality of colors of ink to be applied to the unit area from image data to be printed in the unit area; and

a setting unit that sets an amount of processing liquid to be applied to the unit area based on both the total number and ratio.

Further features of the present invention will become apparent from the following description of exemplary embodiments (with reference to the attached drawings).

### BRIEF DESCRIPTION OF THE DRAWINGS

FIG. 1 is a perspective drawing illustrating the construction of an embodiment of printer to which the present invention can be applied;

FIG. 2 is a block diagram of the control circuit of the printer in FIG. 1;

FIG. 3 is a diagram illustrating an example of printing a red image in forward and backward scans of 1-pass bi-directional printing in the case where processing liquid is not applied;

FIGS. 4A and 4B are schematic diagrams illustrating the fixed state of ink on a printing medium when printing a red image using forward and backward scanning;

FIG. 5 is a diagram illustrating an example of printing a red image in forward and backward scans of 1-pass bi-directional printing in the case where processing liquid is applied;

FIGS. 6A and 6B are schematic diagrams illustrating the fixed state of ink on a printing medium when printing a red image using forward and backward scanning when processing liquid is applied;

FIGS. 7A to 7D are schematic diagrams illustrating the appearance of the fixed state and color of ink when the amount of processing liquid applied is changed;

FIG. 8 is a function block diagram illustrating a data conversion process of converting input image data to printing data that can be printed by an inkjet printer;

FIG. 9 is a schematic diagram explaining a block that is the object of processing by the processing liquid data generation process;

FIG. 10 is a flowchart illustrating the procedure of the processing liquid data generation process 1006;

FIG. 11 is a flowchart illustrating the procedure of a primary-color and secondary-color determination process;

FIG. 12 is a flowchart illustrating the procedure of a hue area determination process;

FIG. 13 is a flowchart illustrating the procedure of a saturation area determination process;

FIG. 14 is a flowchart illustrating the procedure of a color determination process;

FIG. 15 is a flowchart illustrating the procedure of a C_{H}H₁ color determination process;

FIG. 16 is a flowchart illustrating the procedure of a C_{H}H_{M} color determination process;

FIG. 17 is a flowchart illustrating the procedure of a C_{H}H₂ color determination process;

FIG. 18 is a flowchart illustrating the procedure of a C_{L}H₁ color determination process;

FIG. 19 is a flowchart illustrating the procedure of a C_{L}H_{M} color determination process;

FIG. 20 is a flowchart illustrating the procedure of a C_{L}H₂ color determination process;

FIG. 21 is an image diagram explaining a color area;

FIG. 22 is a schematic diagram for explaining the processing liquid data generation method; and

FIGS. 23A and 23B are diagrams explaining 1-pass and 2-pass bi-directional printing.

### DESCRIPTION OF THE EMBODIMENTS

### Embodiment 1

In the following, embodiments of an inkjet printer of the present invention will be explained with reference to the drawings. In the embodiments explained below, an example of a color inkjet printer that can form a color image will be explained. However, the present invention is not limited to forming a color image, and can also be applied to forming a black and white image.

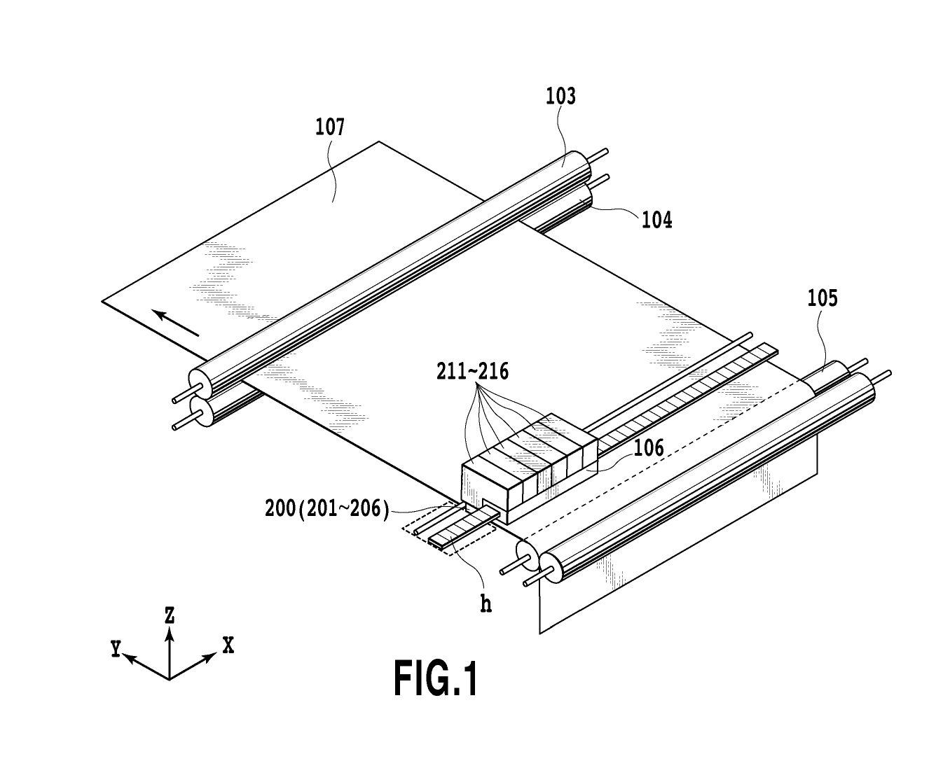

FIG. 1 is a perspective drawing illustrating the construction of an embodiment of an inkjet printer to which the present invention can be applied. Ink tanks 211 and 216 store processing liquid, and ink tanks 212 to 215 respectively store four colors of ink (yellow, magenta, cyan and black: Y, M, C, B). The ink tanks 211 to 216 are such that they are capable of supplying the processing liquid and the four colors of ink to the nozzles 201 to 206 of the printing head 200. The nozzles 201 to 206 of the printing head 200 has a plurality of rows in the main scanning direction X and conveying direction Y, and are such that they can apply processing liquid and ink, that is supplied to the ink tanks 211 to 216, to a medium. In other words, the nozzles 202 to 205 are capable of ejecting a plurality of kinds of ink, and nozzles 201 and 206 are capable of ejecting processing liquid. The processing liquid is a liquid that acts on ink by coming in contact with the ink, and for example, is a liquid that contains a component that cannot dissolve the coloring material in ink, or has a function to cause the coloring material to precipitate out. A liquid that can improve the water resistance of a printed image, and has the effect of improving printability such as increasing the density, preventing bleeding, reducing the feathering phenomenon and the like can be used as this kind of liquid.

A conveying roller 103 conveys printing medium 107 by rolling while holding the printing medium 107 between the conveying roller and an auxiliary roller 104, and also performs the role of holding the printing medium (printing paper) 107. A carriage 106 is such that the ink tanks 211 to 216 and the printing head 200 can be mounted therein, and with the printing head and ink tanks mounted, can move them forward and backward in the X direction. Processing liquid and ink are ejected from the printing head while the carriage 106 is moving forward and backward, and as a result, an image is printed on the printing medium. During non-printing operation such as during the return operation of the printing head 200, the carriage 106 is controlled so that it waits at a home position h that is indicated by the dashed line in FIG. 1.

At the beginning of printing, the printing head 200, which is positioned together with the carriage 106 at the home position h illustrated in FIG. 1, moves in the X direction in the figure when a start printing instruction is inputted, and by ejecting processing liquid and ink, prints an image on the printing medium 107. During one movement of this printing head, printing is performed in an area having a width that corresponds to the range of the arrays of nozzles of the printing head. After a printing scan has finished and before the next printing scan begins, the conveying roller 103 rotates and conveys the printing medium in the Y direction in FIG. 1. The printing head then moves in the minus X direction toward the home position h, and by ejecting processing liquid and ink, prints an image on the printing medium 107. After a printing scan has finished and before the next printing scan begins, the conveying roller 103 rotates and conveys the printing medium in the Y direction in FIG. 1. By repeating print scanning by the printing head and conveying of the printing medium in this way, an image is completed on the printing medium 107. The printing operation of ejecting ink from the printing head 200 is performed according to control by a control unit that will be described later.

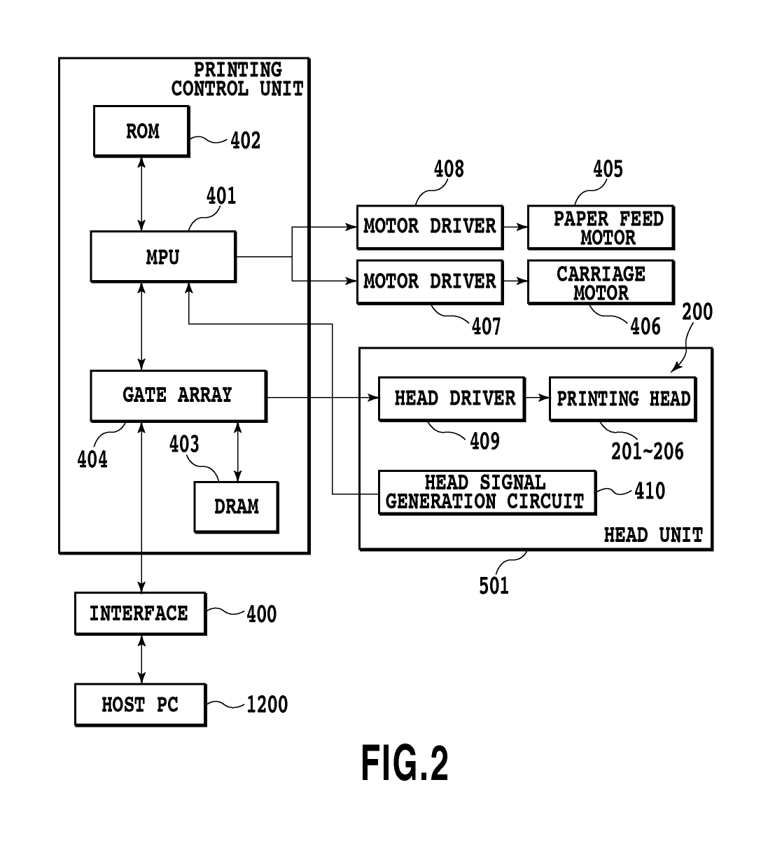

Next, the construction of the printing control circuit of the inkjet printer illustrated in FIG. 1 will be explained with reference to the block diagram illustrated in FIG. 2. In FIG. 2, 400 is an interface that inputs printing signals and control signals related to printing, and 401 is a MPU (Micro Processing Unit). Moreover, 402 is a ROM (Read Only Memory) that stores control programs that are executed by the MPU 401. In FIG. 2, 403 is a dynamic type RAM (Dynamic Random Access Memory (DRAM)) that stores various kinds of data (for example, printing signals and control signals for printing that are supplied to the printing head 200). The number of printing dots and the number of times the printing head 200 has been replaced can also be stored in the RAM 403. In the figure, 404 is a gate array that performs control for supplying printing data to the printing head 200, and also performs control for transferring data among the interface 400, MPU 401 and DRAM 403.

Furthermore, 406 is a carriage motor for moving the carriage 106 on which the printing head 200 is mounted forward and backward. In the figure, 405 is a conveying motor for rotating the conveying roller 103 for conveying the printing medium 107. Also, 408 and 407 are motor drivers for driving the conveying motor 405 and carriage motor 406, respectively. In FIG. 2, 409 is a head driver that drives the printing head 200, with the number of head drivers corresponding to the number of printing head nozzles. Moreover, 410 is a head signal generation circuit that provides signals to the MPU indicating the type and number of printing heads 200 that are mounted in the head unit 501 that corresponds to the carriage 106.

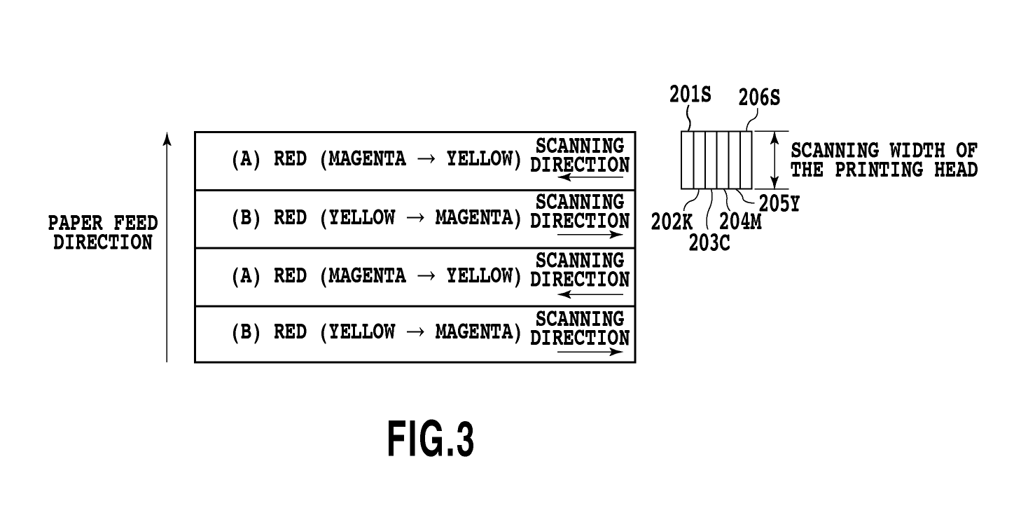

Next, the reason that color unevenness occurs in an image due to differences in the printing order of ink in the main scan in the forward direction (forward direction scan) and the main scan in the backward direction (backward direction scan) will be explained. FIG. 3 is a diagram illustrating an example of printing a red image in forward and backward scans of 1-pass bi-directional printing in the case where processing liquid is not applied. In a forward scan and backward scan of the printing head, the printing order of magenta ink and yellow ink differs (in the forward scan, the order is magenta→yellow, and in the backward scan, the order is yellow→magenta), so color unevenness occurs between adjacent images for each scanning width of the printing head.

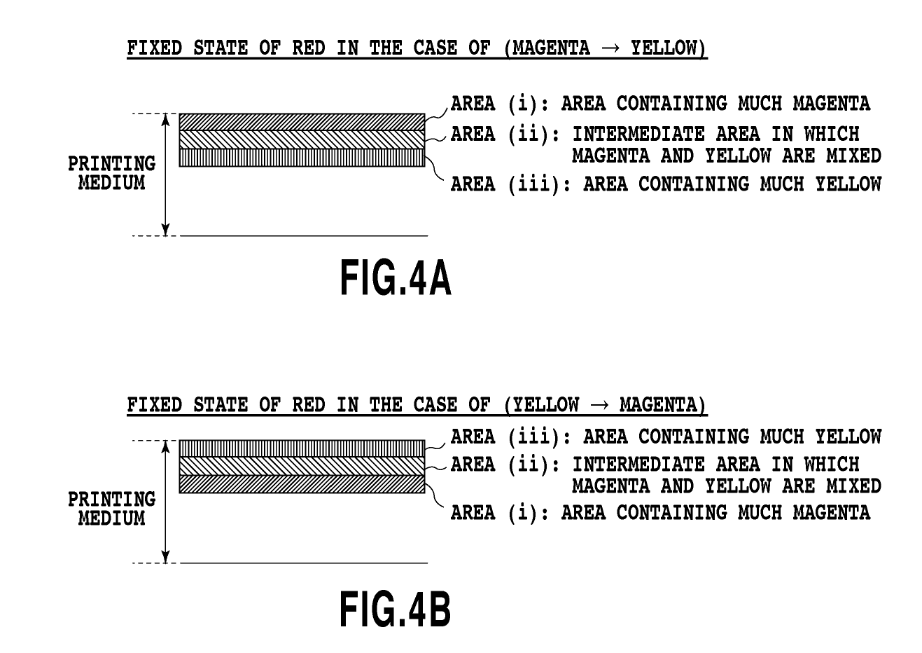

FIG. 4A is a schematic diagram illustrating the fixed state of ink on a printing medium in the case where ink is printed during forward scanning in the order magenta→yellow. The magenta ink that is printed first stops on the surface layer of the printing medium, and the yellow ink that is printed later permeated into the printing medium, so three areas are formed near the surface layer of the medium. Area (i) is an area that includes much magenta. Area (ii) is an intermediate area in which magenta and yellow are mixed. Area (iii) is an area that includes much yellow. In this case, area (i) is formed on the very top surface layer of the printing medium, so when observing the printed matter, the M component is intense and the red looks more from magenta.

FIG. 4B is a schematic diagram illustrating the fixed state of ink on a printing medium in the case where ink is printed during backward scanning in the printing order yellow→magenta. Opposite from forward scanning, area (iii) is formed on the very top surface layer of the printing medium, so when observing the printed matter, the Y component is intense and the red looks more from yellow. In this way, due to the printing order in forward scanning and backward scanning, reds having different tinge are formed, so that color unevenness occurs for each scanning width, causing the image quality to deteriorate.

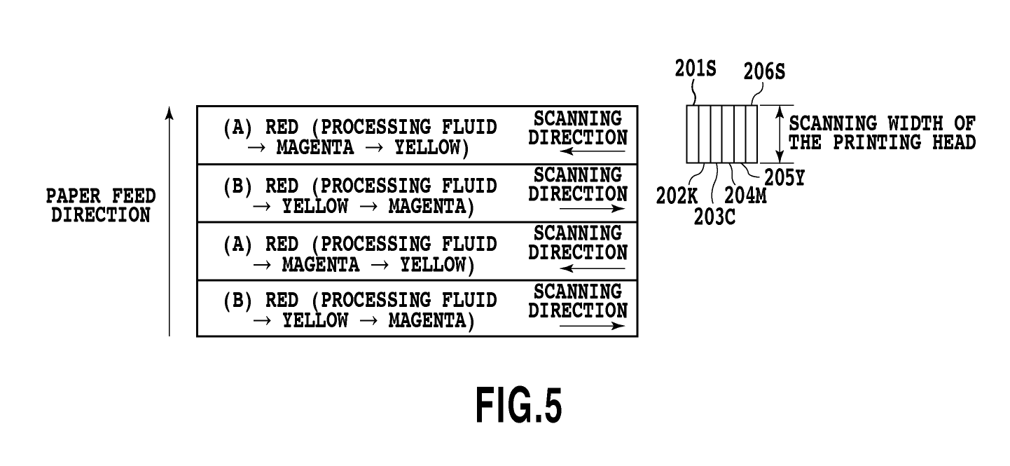

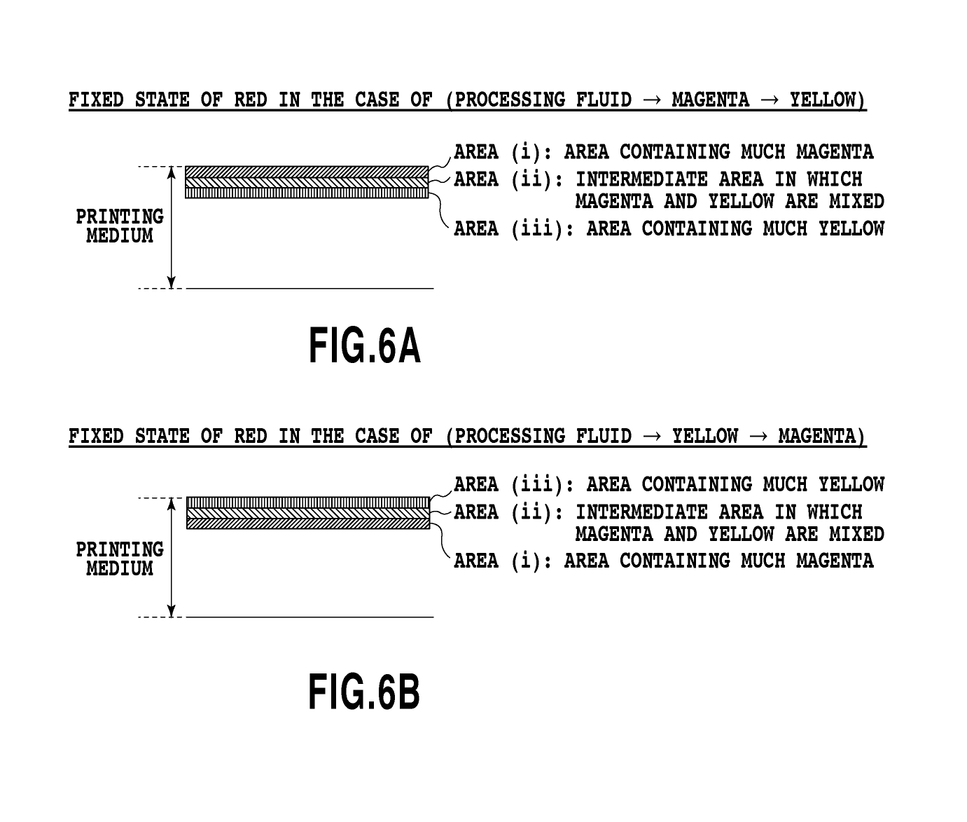

FIG. 5 is a diagram illustrating an example of printing a red image in forward and backward scans of 1-pass bi-directional printing in the case where processing liquid is applied. Here, processing liquid is always ejected from the printing head and applied to the printing medium before the ink is printed. During forward scanning, processing liquid is ejected from the nozzle 201 of the printing head 200, and during backward scanning, processing liquid is ejected from the nozzle 206, so that processing liquid can always be applied before printing with ink. Even in the case where printing liquid is applied, the printing order of magenta ink and yellow ink during forward scanning and backward scanning differs (in forward scanning, the order is processing liquid→magenta→yellow, and in backward scanning, the order is processing liquid→yellow→magenta), so color unevenness occurs in each scanning width of the printing head. FIG. 6A is a schematic diagram illustrating the fixed state of ink on a printing medium in the case where ink is printed during forward scanning in the printing order processing liquid→magenta→yellow. FIG. 6B is a schematic diagram illustrating the fixed state of ink on a printing medium in the case where ink is printed during backward scanning in the printing order processing liquid→yellow→magenta. Even when processing liquid is applied, the tendency of ink that is printed first stopping on the surface layer of the printing medium, and the ink that is printed later permeating into the printing medium does not change. However, by reacting with the processing liquid, the ink is fixed in a more narrow area on the surface layer of the printing medium, so the difference in color due to the printing order is more remarkable, and image quality deteriorates.

Next, the relationship between the amount of processing liquid used and the fixed state of the ink and how color appears will be explained.

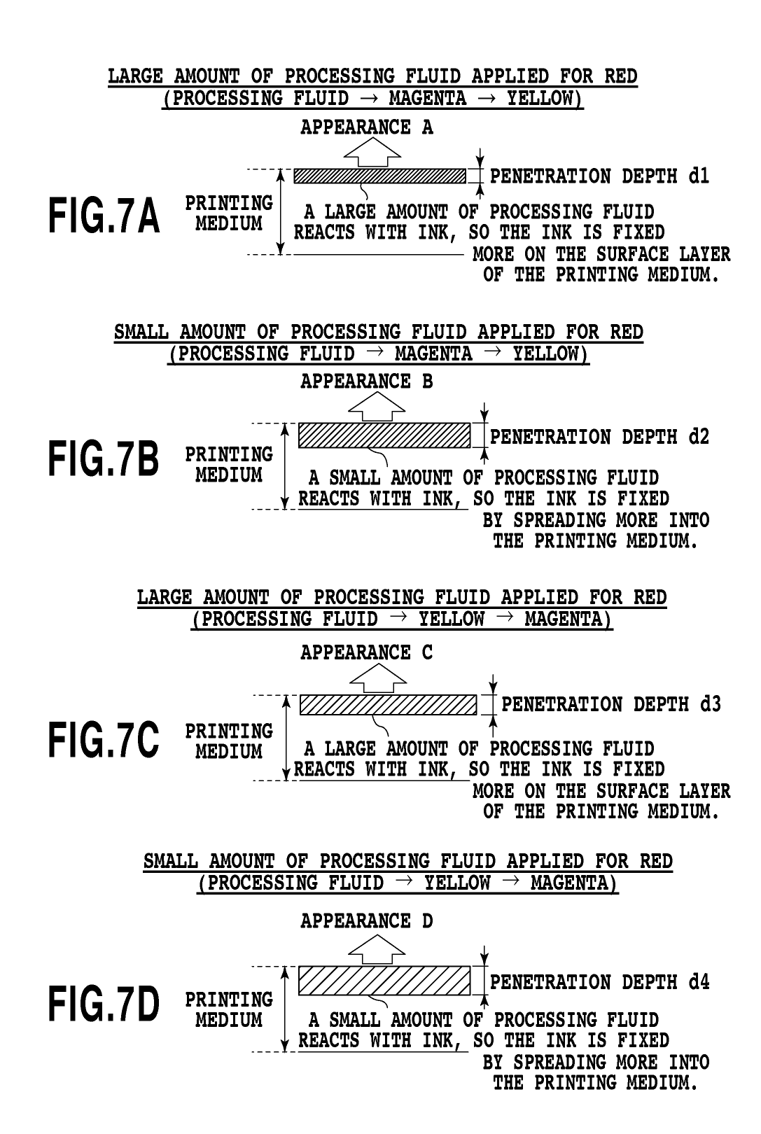

FIGS. 7A to 7D are schematic diagrams illustrating the appearance of the fixed state and color of ink when the amount of processing liquid applied during forward scanning and backward scanning is changed. FIG. 7A illustrates the case where, when printing is performed during forward scanning, the amount of processing liquid applied in the printing order processing liquid→magenta→yellow is relatively large. The permeation depth of the ink is d1. In this case, the amount of processing liquid that reacts with the ink is large, so the ink is fixed more on the surface layer of the printing medium. Similarly, 7B illustrates the case where, when printing is performed during forward scanning, the amount of processing liquid applied in the printing order processing liquid→magenta→yellow is relatively small. The permeation depth of the ink is d2. In this case the amount of processing liquid that reacts with the ink is small, so compared with the case where the amount of processing liquid is large, ink is fixed by spreading more into the printing medium. In this way, the fixed state of ink on the printing medium changes according to the difference in the amount of processing liquid. As a result, the appearance of the color when observing the printing matter is appearance A when there is much processing liquid, and appearance B when there is little processing liquid. In other words, even though the amount of ink that is printed is the same, the color looks different depending on the amount of processing liquid that is applied.

FIG. 7C illustrates the case where, when printing is performed during backward scanning, the amount of processing liquid applied in the printing order processing liquid→yellow→magenta is relatively large. The permeation depth of the ink is d3. FIG. 7D illustrates the case where, when printing is performed during backward scanning, the amount of processing liquid applied in the printing order processing liquid→yellow→magenta is relatively small. The permeation depth of the ink is 4d. In the case of backward scanning, as in the case of forward scanning, the appearance of the color when observing the printed matter is appearance C when the amount of processing liquid is large, and is appearance D when the amount of processing liquid is small. In other words, even though the amount of ink printed is the same, the color appears different depending on the amount of processing liquid used. Moreover, the permeation depth becomes a different depth depending on the amount of processing liquid or the printing order.

Incidentally, even when the color differs in forward and backward scanning and color unevenness occurs under conditions when the amount of processing liquid applied is the same, by changing the amount of processing liquid applied in forward scanning and backward scanning, combinations result where the color is close. Taking FIGS. 7A to 7D as an example, in the appearances of color A (large amount of processing liquid) and C (small amount of processing liquid), the color is greatly different; however, the colors observed in color appearances A (large amount of processing liquid) and D (small amount of processing liquid) are nearly the same. In other words, this means that in forward and backward scanning, by applying an optimum amount of processing liquid so that the color becomes the same, it is possible to reduce color unevenness.

Moreover, the optimum amount of processing liquid that is capable of reducing color unevenness in forward scanning and backward scanning is not constant, and in addition to physical differences due to the composition of the ink itself, this optimum amount changes due to difference in the amount of reaction between each ink and the processing liquid. For example, in the case where there is a strong reaction between the processing liquid and yellow ink, a week reaction with magenta ink and an intermediate level reaction with cyan ink, the optimum amounts of processing liquid, that when combined with each ink, results in color that is the same in forward and backward scanning, are naturally different. In order to reduce color unevenness, it is necessary to adequately apply the optimum amount of processing liquid according to the ratio of ink used in forming an image.

Table 1 illustrates the relationship between the amounts of processing liquid applied that result in the same color in forward and backward scanning when red having different printing duty is printed.

TABLE 1

| | | | Amount of | Amount of |
|---|---|---|---|---|
| | | | processing | processing |
| | | | liquid in | liquid in |
| | Amount of | Amount of | forward | backward |
| | magenta ink | yellow ink | scanning | scanning |
| Red 1 | 20% | 20% | 10% | 15% |
| Red 2 | 50% | 50% | 20% | 40% |

The printing duty referred to here, is the percentage of the total number of dots formed in a plurality of dot formation areas with respect to the number of the plurality of dot formation areas, with the printing duty being 100% in the case where one dot is formed in each of the plurality of dot formation areas. Therefore, when one dot is formed in ½ of the areas, for example, the duty is 50%. Moreover, when two dots are formed in each of the areas, the duty becomes 200%.

In Table 1, for red 1, the duty of magenta is 20% and the duty of yellow is 20% for a total duty of 40%, and for this combination, when the amount of processing liquid applied in the forward scanning is 10%, and the amount of processing liquid that is applied in the backward scanning is 15%, the colors in the forward and backward scanning are the closest.

For red 2, the duty of magenta is 50% and the duty of yellow is 50% for a total duty of 100%, and for this combination, when the amount of processing liquid applied in the forward scanning is 20%, and the amount of processing liquid that is applied in the backward scanning is 40%, the colors in the forward and backward scanning are the closest. This indicates that even for red having the same hue, when the total duty is different, the optimum amounts of processing liquid for bringing the colors in forward and backward scanning closer together becomes different.

That is, in order to reduce color unevenness caused by the printing order of ink, it is necessary to adequately apply the optimum amount of processing liquid according to the relative percentages (ratios) of a plurality of kinds of ink and the total amount of a plurality of kinds of ink (total duty) that are applied to a unit area.

Next, a method of determining the amount processing liquid will be explained. This method will be explained using the case of printing red, which is formed with magenta having a duty of 50% and yellow having a duty of 50% in both the forward and backward scanning, as an example. Table 2 is a table that illustrates the relationship between the amount of processing liquid applied in a printing order 1 (first printing order) and a printing order 2 (second printing order), and the measured color value when the printed matter is measured using a colorimeter.

TABLE 2

| Printing order 1 | | Printing order 2 | |
|---|---|---|---|
| Amount of | Color | Amount of | Color |
| processing | measurement | processing | measurement |
| liquid applied | value | liquid applied | value |
| 0% | (L*1, a*1, | 0% | (L*4, a*4, |
| | b*1) | | b*4) |
| 20% | (L*2, a*2, | 20% | (L*5, a*5, |
| | b*2) | | b*5) |
| 40% | (L*3, a*3, | 40% | (L*6, a*6, |
| | b*3) | | b*6) |

In printing order 1, printing is performed in the order processing liquid→magenta→yellow, and in printing order 2, printing is performed in the order processing liquid→yellow→magenta. The symbol in the color measurement values in the table represent the values for L*a*b*. In Table 2, in the case where the amount of processing liquid in forward scanning in printing order 1 is 20%, (L*, a*, b*)=(L*2, a*2, b*2).

Next, all of the color differences (ΔE) of combinations of color measurement values of printed matter in printing order 1 and color measurement values of printed matter in printing order 2 are calculated. The color difference (ΔE) is calculated using the following equation for the case where the amount of processing liquid in printing order 1 is 20%, and the amount of processing liquid in printing order 2 is 20% as an example.

ΔE={(L*2−L*5)²+(a*2−a*5)²+(b*2−b*5)²}^{1/2}

Table 3 is a table illustrating the relationship between the combination of the color measurement value of the printed matter (first image) in printing order 1 and the color measurement value of the printed matter (second image) in printing order 2 and the calculated color difference.

TABLE 3

| | |
|---|---|
| Combinations for calculating the color | Color difference |
| difference | (ΔE) |

| | | |
|---|---|---|
| (L*1, a*1, b*1) | (L*4, a*4, b*4) | a |
| (L*1, a*1, b*1) | (L*5, a*5, b*5) | b |
| (L*1, a*1, b*1) | (L*6, a*6, b*6) | c |
| (L*2, a*2, b*2) | (L*4, a*4, b*4) | d |
| (L*2, a*2, b*2) | (L*5, a*5, b*5) | e |
| (L*2, a*2, b*2) | (L*6, a*6, b*6) | f |
| (L*3, a*3, b*3) | (L*4, a*4, b*4) | g |
| (L*3, a*3, b*3) | (L*5, a*5, b*5) | h |
| (L*3, a*3, b*3) | (L*6, a*6, b*6) | i |

In Table 3, when printing in forward and backward scanning with the combination having the smallest color difference, means that the occurring color unevenness is a minimum. The amount of processing liquid applied is also determined by selecting the combination having the smallest color difference. For example, in Table 3, in the case where the color difference f has the smallest value, it is possible to reduce color unevenness by applying 20% processing liquid in printing order 1 and by applying 40% processing liquid in printing order 2. In other words, the optimum amount of processing liquid that is applied in each printing order is correlated to the color difference between the first image and the second image.

The amount of processing liquid applied in each printing order is determined in this way. Moreover, in this embodiment, an L*a*b* color system was explained; however, it is also possible to use another color system. Furthermore, in this embodiment, the amount of processing liquid applied was determined by selecting the combination having the smallest color difference. However, in cases where it is necessary to apply a fixed amount or greater of processing liquid in order to obtain a certain density, a combination having a small color difference can be selected from combinations of a fixed amount of processing liquid or greater.

Next, the process for generating processing liquid data according to the percentage of ink used to form an image, and the total duty will be explained.

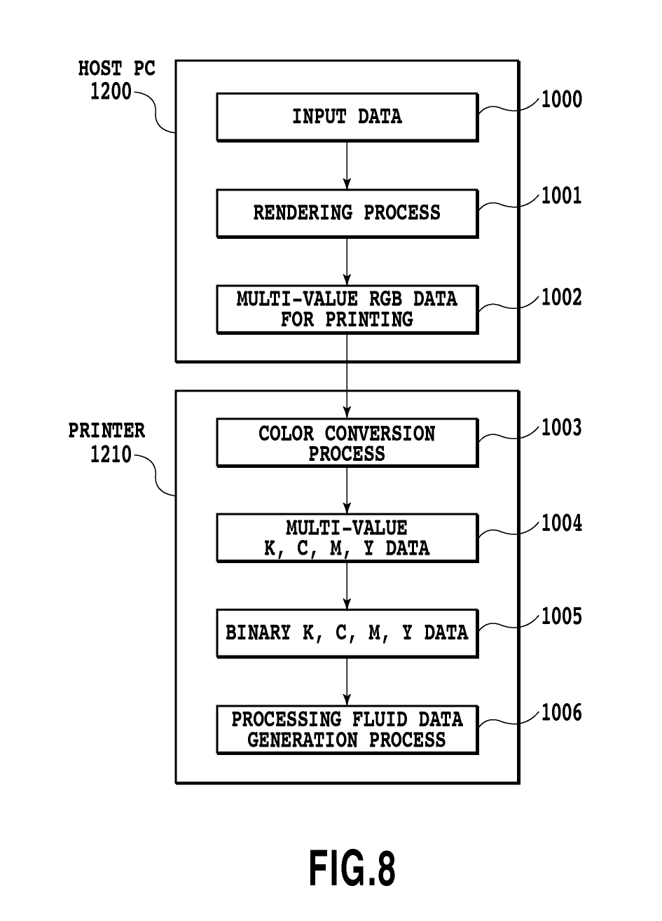

FIG. 8 is a function block diagram illustrating a data conversion process of converting input image data to printing data that can be printed by an inkjet printer of this embodiment. The printer 1210 illustrated in FIG. 8 corresponds to the printing control unit 500 in the construction illustrated in FIG. 2. Moreover, the host computer (hereafter referred to as host PC) 1200 illustrated in FIG. 8 exchanges data that will be described below with the printer 1210 via the interface 400 in FIG. 2.

The host PC 1200, first, performs rendering 1001 on input data (input image data) 1000 that is received from an application using a resolution of 300 dpi for example. By doing so, multi-value (in this embodiment, 256 value) RGB printing data 1002 is generated. The generated multi-value RGB data 1002 is transferred to the printer 1210.

The printer 1210 performs a conversion process 1003 for converting from the multi-value RGB data 1002 to multi-value KCMY data 1004. The converted KCMY data 1004 is quantized by a specified quantization method to binary data having a resolution of 300 dpi. In this embodiment, the data is quantized by an error diffusion method to binary data having a resolution of 300 dpi that can be printed by a printing head. Finally, the printer 1210 performs a processing liquid data generation process 1006 (that will be described later) based on the binary KCMY data 1005.

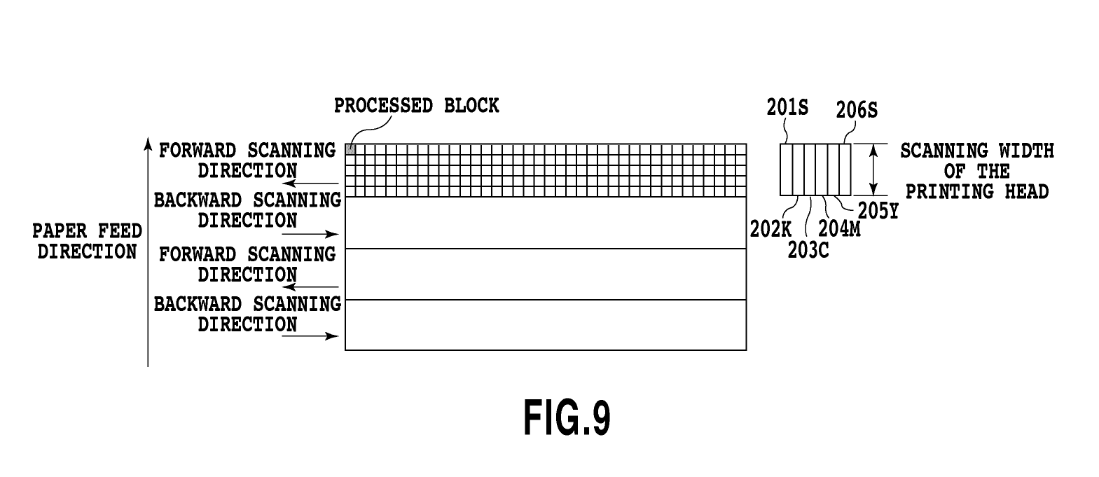

In this embodiment, printing data is divided into a plurality of blocks, or in other words, is divided into specified unit areas, and a dot count is performed, then processing liquid data is generated based on the result. That is, the amount of processing liquid is determined according to the relative percentages of a plurality of kinds of ink that are to be printed in the unit areas that are regulated for each specified unit area of printing data, and the total amount of the plurality of kinds of ink, processing liquid data is generated based on that amount of processing liquid. FIG. 9 is a schematic diagram explaining a block that is the object of processing by the processing liquid data generation process 1006. The size of one dot count block is 16×16 dots (300 dpi). The number of nozzles in the printing head of this embodiment is 80, and each nozzle is arranged with uniform spacing of 300 dpi in the nozzle array direction (not illustrated in the figure). In the paper feed direction, 80 (300 dpi), which corresponds to the head width, is divided into five equal parts, to form five processing blocks. In the main scanning direction, the printing data is divided and arranged into a plurality of items of data equal to the printing width. Data for one printing scan by the printing head, or in other words, data for (number of nozzles)×(number of dots in the scanning direction) is divided into five items of data in the paper feed direction (sub scanning direction), and N uniform divisions in the main scanning direction, to form N number of dot count blocks. In the case of this embodiment, in the main scanning direction, the 8-inch printing width is divided with N=150. Moreover, in each processing block, for 16 (vertical)×16 (horizontal) pixels, data is correlated to “1” for ejection, and “0” for no ejection.

The processing liquid data is processed in order in the main scanning direction from the processing block in question (unit area) in the upper left illustrated in FIG. 9, and after one row of processing is completed, the next row is similarly processed in the main scanning direction from the left end, and processing liquid data corresponding to all of the printing data is generated. In this embodiment, the size of the processing block was 16×16 dots (300 dpi); however, when another size is preferred due to the printer construction or ink composition, the size can be set to an arbitrary size.

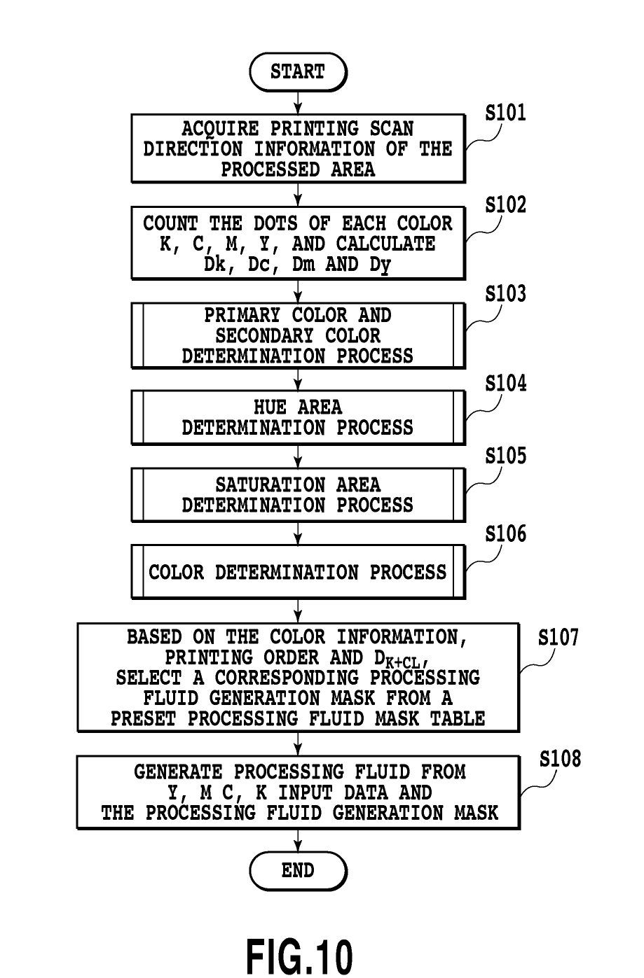

FIG. 10 is a flowchart illustrating the procedure of the processing liquid data generation process 1006. The symbols used in the following explanation are explained below.

Dk: Dot count value for black

Dc: Dot count value for cyan

Dm: Dot count value of magenta

Dy: Dot count value for yellow

Dₘₐₓ: Maximum value among Dy, Dm and Dc

D3ₘᵢₙ: Minimum value among Dy, Dm and Dc

D_{mid}: Value that is not the maximum or minimum among Dy, Dm and Dc

D_{CL}: Total value of Dy, Dm and Dc

D_{K+CL}: Total value of Dy, Dm, Dc and Dk

D1 (No. of primary color dots): D1=Dₘₐₓ−D_{mid}

D2 (No. of secondary color dots): D2=D_{mid}−D3ₘᵢₙ

D3 (No. of tertiary color dots): D3=D3ₘᵢₙ+D_{K}

First, the process acquires information of whether the area being processed is an area that is printed in forward scanning, or an area that is printed in backward scanning, and determines the printing order of ink (S101). Here, the ink printing order is uniquely set in the scanning to the order black→cyan→magenta→yellow in forward scanning, and to the order yellow→magenta→cyan→black in backward scanning. In this case, the printing order in forward scanning is taken to be printing order 1, and the printing order in backward scanning is taken to be printing order 2. Next, the process performs a dot count of printing data for each color K (black), C (cyan), M (magenta) and Y (yellow), and acquires the dot count values Dk, Dc, Dm and Dy for each color (S102). The process then, based on the acquired dot count values, performs a primary color and secondary color determination process (described later) (S103), hue area determination process (S104), and saturation area determination process (S105). Then, based on the results of the three determination processes S103 to S105, the process performs a color determination process (S106) for the processed block (described later). Next, the process reads a corresponding processing liquid generation mask from a processing liquid mask table that is preset from the color information obtained from the color determination process, printing order and total value of Dk, Dc, Dm and Dy (S107). Finally, the process generates processing liquid data from the K, C, M and Y input data and processing liquid generation mask data (S108) and ends.

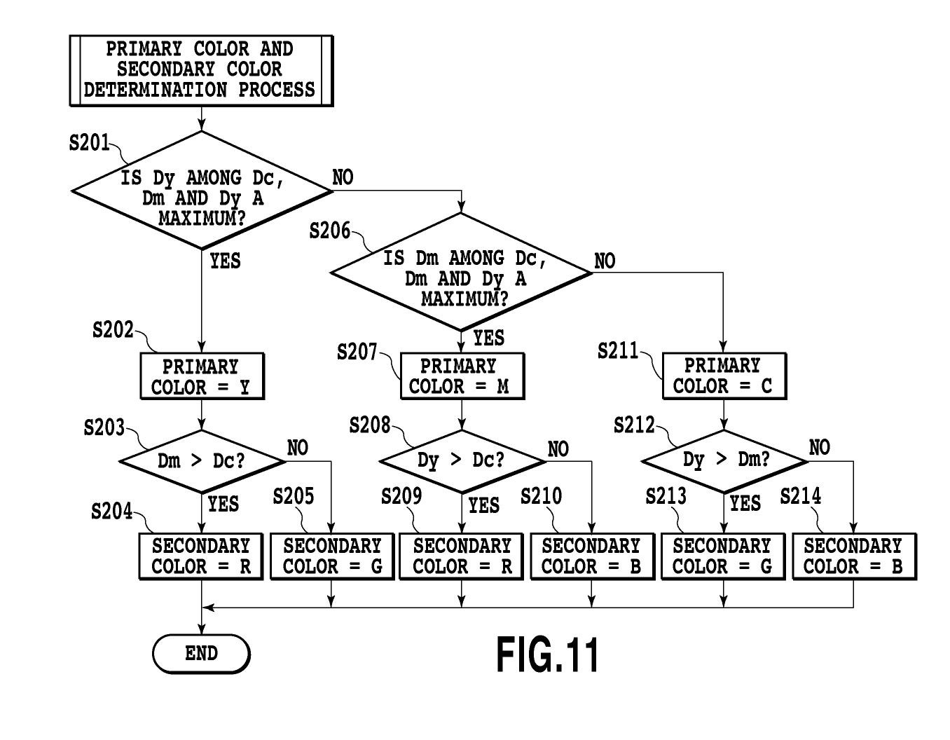

FIG. 11 is a flowchart illustrating the procedure of a primary-color and secondary-color determination process performed in step S103. First, the process determines whether or not Dy among the values Dc, Dm and Dy is a maximum value (S201). When Dy is a maximum value, processing proceeds to step S202 and the primary color in the processed area is determined to be Y. Otherwise, processing advances to step S206. After the primary color is determined to be Yin step S202, the process advances to step S203 and determines whether or not Dm>Dy. When Dm>Dy, the secondary color in the processed area is determined to be R (S204), otherwise the secondary color is determined to be G (S205).

Next, in step S206, the process determines whether or not Dm among Dc, Dm and Dy is a maximum. When Dm is a maximum value, processing advances to step S202, and the primary color in the processed area is determined to be M. When Dm is not a maximum, processing advances to step S211, and the primary color is determined to be C. In step S207, after the primary color is determined to be M, the process advances to step S208 and determines whether or not Dy>Dc. When Dy>Dc, the secondary color in the processed area is determined to be R (S204), otherwise the secondary color is determined to be B (S205).

After the primary color has been determined to be C in step S211, the process advances to step S212 and determines whether or not Dy>Dm. When Dy>Dm, the secondary color in the processed area is determined to be G (S213), otherwise the secondary color is determined to be B (S214). The primary color and secondary color determination process then ends.

In this way, the process determines which primary color area C, M or Y, and which secondary color area R, G or B the processed area belongs to.

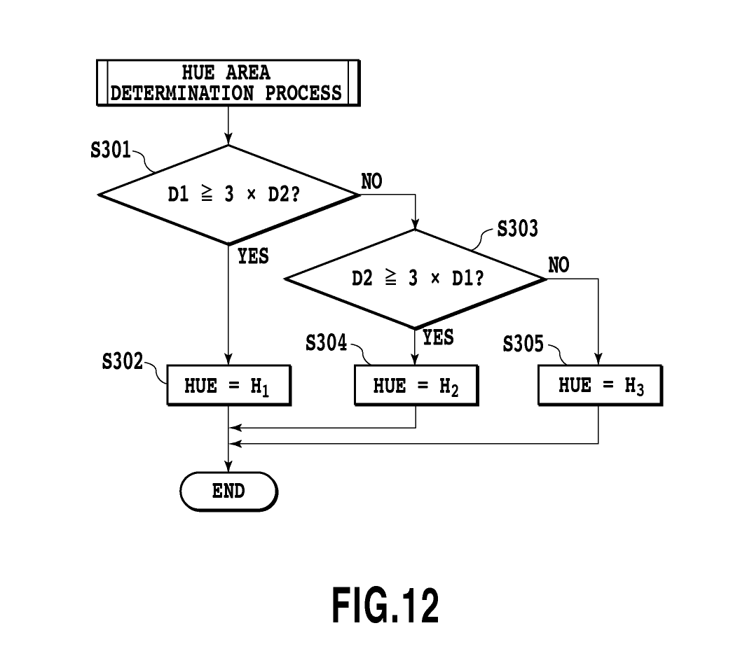

FIG. 12 is a flowchart illustrating the procedure of the hue area determination process performed in step S104.

First, the process determines whether or not D1≧3×D2 (S301). When D1 is 3×D2 or greater, the hue is determined to be primary color area H1 (S302). When D1 is less than 3×D2, the process then determines whether or not D2≧3×D1 (S303). When D2 is 3×D1 or greater, the hue is determined to be secondary color area H2 (S304). When D2 is less than 3×D1, the hue is determined to be in the intermediate area (S305). The hue area determination process then ends.

In this way, the process determines which area, primary color, secondary color or intermediate area, the hue of a processed area belongs to. The hue area determination process of this embodiment performed classification for only three stages, primary color, secondary color or intermediate area; however, when it is desired to perform finer control, it is possible to provide threshold values for a plurality of stages and perform classification for a plurality of hue areas.

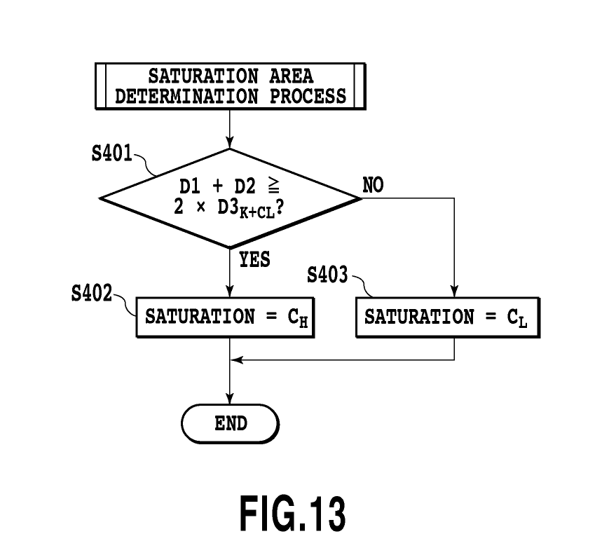

FIG. 13 is a flowchart illustrating the procedure of a saturation area determination process that is performed in step S105. First, the process determines whether or not D1+D2≧2×D3_{K+CL} (S401). When D1+D2 is 2×D3_{K+CL} or greater, the saturation area is determined to be the high saturation area C_{H} (S402). When D1+D2 is less than 2×D3_{K+CL}, the saturation area is determined to be the low saturation area C_{L} (S305). The saturation area determination process of this embodiment only performs classification in two stages, high saturation area C_{H} and low saturation area C_{L}; however, when it is desired to perform finer control, it is possible to provide threshold values for a plurality of stages and perform classification for a plurality of saturation areas.

Next, based on the determination results of the primary color and secondary color determination process (S103), the hue area determination process (S104) and the saturation area determination process (S105), the color determination process of step S106 determines which color area the processed area belongs to.

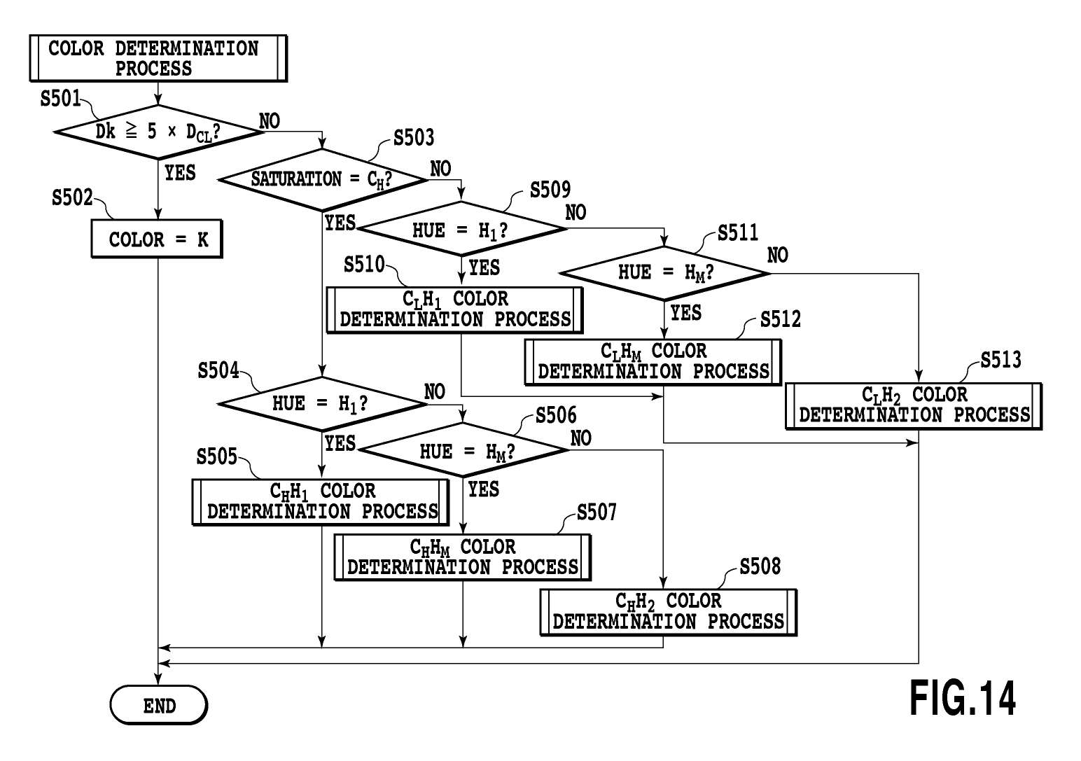

FIG. 14 is a flowchart illustrating the procedure of the color determination process performed in step S106. First, the process determines whether or not Dk≧5×D_{CL} (S501). When it is determined that Dk is 5×D_{CL} or greater, the color area is determined to be K (S502). When Dk is less than 5×D_{CL}, the process determines whether or not the saturation area is C_{H} (high saturation area) (S503). When the saturation area is C_{H}, the process then determines whether the hue area is H₁ (S504). When the hue area is H₁, the process performs a C_{H}H₁ color determination process (S505) that will be described later. In step S504, when the hue area is not H₁, the process determines whether or not the hue area is H_{M} (S506). When the hue area is H_{M}, the process performs a C_{H}H_{M} color determination process (S507) that will be described later. In step S506, when the hue area is not H_{M}, the process performs a C_{H}H₂ color determination process (S508) that will be described later.

Next, in step S503, when the saturation area is not C_{H}, the process then determines whether or not the hue area is H₁ (S509). When the hue area is H₁, the process performs a C_{L}H₁ color determination process (S510) that will be described later. In step S509, when the hue area is not H₁, the process determines whether or not the hue area is H_{M} (S511). When the hue area is H_{M}, the process performs a C_{L}H_{M} color determination process (S512) that will be described later. In step S511, when the hue area is not H_{M}, the process performs a C_{L}H₂ color determination process (S513) that will be described later. The color determination process then ends.

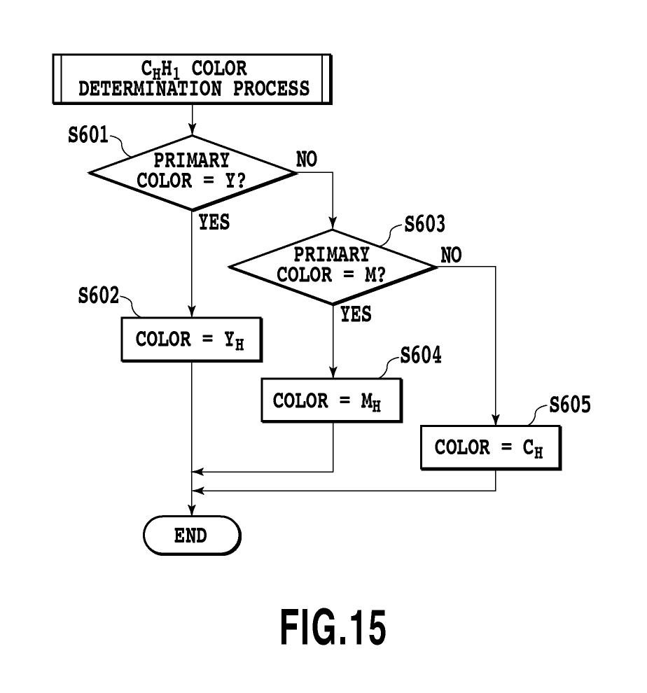

FIG. 15 is a flowchart illustrating the procedure of the C_{H}H₁ color determination process (S505). First, the process determines whether or not the primary color determination result is Y (S601). When the primary color determination result is Y, the color area is determined to be Y_{H} (S602). In step S601, when the primary color determination result is not Y, the process determines whether or not primary color determination result is M (S603). When the primary color determination result is M, the color area is determined to be M_{H} (S604). In step S603, when the primary color determination result is not M, the color area is determined to be C_{H} (S605). The C_{H}H₁ color determination process then ends.

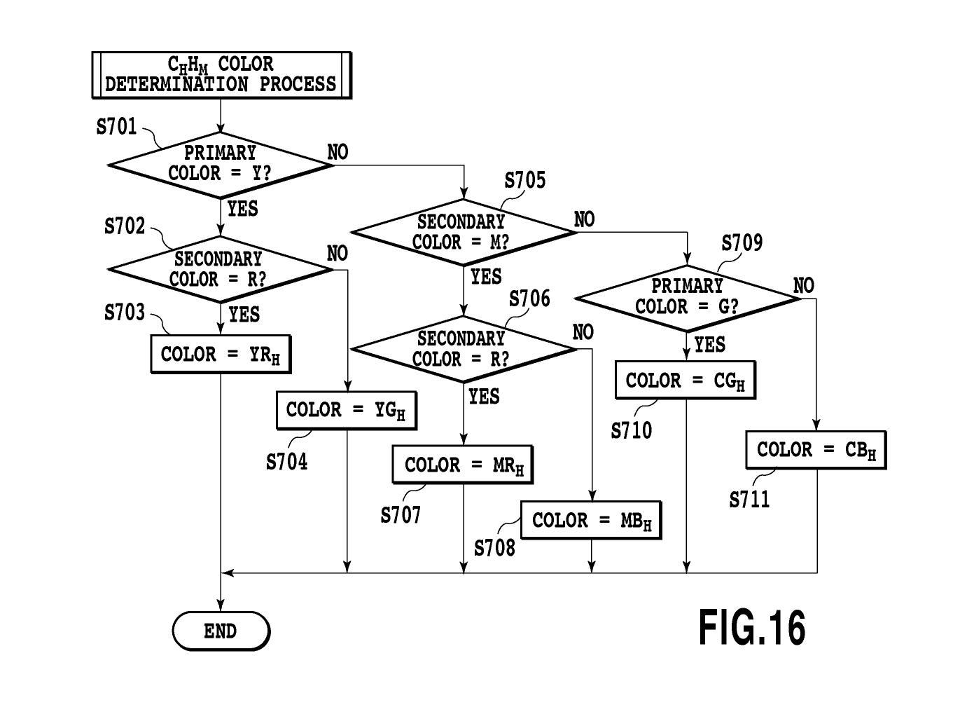

FIG. 16 is a flowchart illustrating the procedure of the C_{H}H_{M} color determination process (S507). First, the process determines whether or not the primary color determination result is Y (S701). When the primary color determination result is Y, the process then determines whether or not the secondary color judgment result is R (S702). When the primary color determination result is Y and the secondary color determination result is R, the color area is determined to be YR_{H} (S703). In step S702, when the secondary color determination result is not R, the hue of the secondary color that includes Y is only G, so the color area is determined to be YG_{H} (S704). In step S701, when the primary color determination result is not Y, the process then determines whether or not the primary color determination result is M (S705). When the primary color determination result is M, the process then determines whether or not the secondary color determination result is R (S706). When the secondary color determination result is R, the color area is determined to be MR_{H} (S707). In step S706, when the secondary color determination result is not R, the color area is determined to be MB_{H} (S708). In step S705, when the primary color determination result is not M, the primary color determination result can only be C. The process then determines whether or not the secondary color determination result is G (S709). When the secondary color determination result is G, the color area is determined to be CG_{H} (S710). In step S709, when the secondary color determination result is not G, the color area is determined to be CB_{H} (S711). The C_{H}H_{M} color determination process then ends.

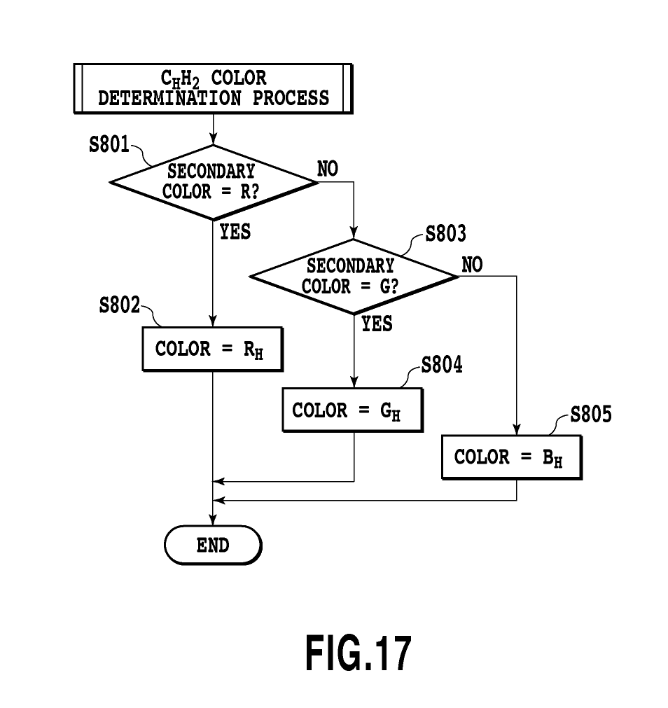

FIG. 17 is a flowchart illustrating the procedure of the C_{H}H₂ color determination process (S508). First, the process determines whether or not the secondary color determination result is R (S801). When the secondary color determination result is R, the color area is determined to be R_{H} (S802). In step S801, when the secondary color determination result is not R, the process determines whether or not the secondary color determination result is G (S803). When the secondary color determination result is G, the color area is determined to be G_{H} (S804). In step S803, when the secondary color determination result is not G, the color area is determined to be B_{H} (S805). The C_{H}H₂ color determination process then ends.

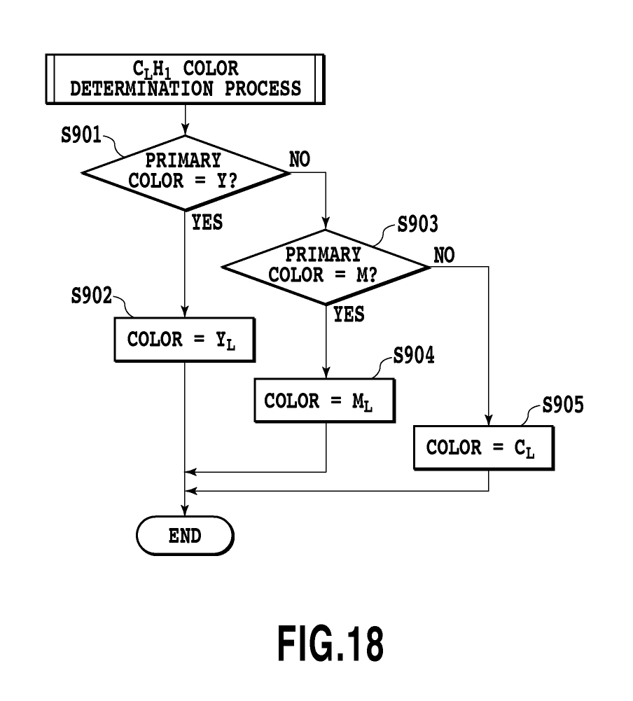

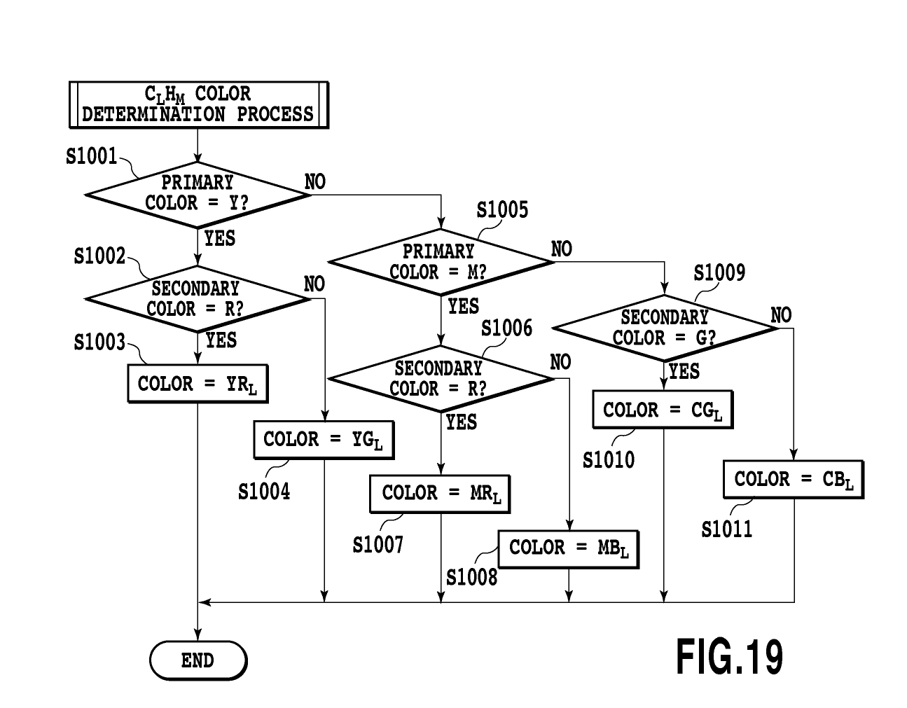

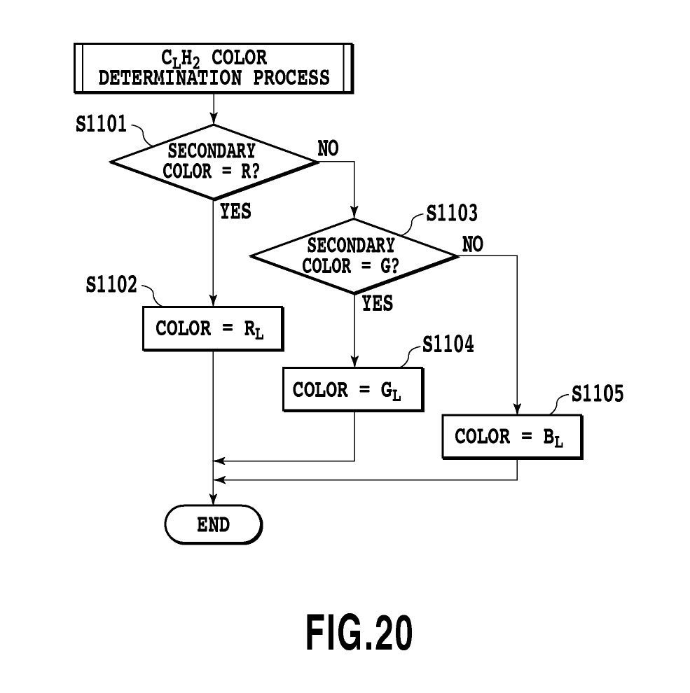

FIG. 18 is a flowchart illustrating the procedure of the C_{L}H₁ color determination process (S510); however, the processing is the same as the C_{H}H₁ color determination process (S505), so an explanation is omitted. Similarly, the C_{L}H_{M} color determination process (S512) in FIG. 19 is the same as the C_{H}H_{M} color determination process (S507), and the C_{L}H₂ color determination process (S513) in FIG. 20 is the same as the C_{H}H₂ color determination process (S508), so that explanations are omitted.

By performing the processes explained above, it is possible to determine which color area a processed block belongs to from the percentage of the dot count value for each color. In other words, it is possible to acquire information that indicates the hue of an image to be printed in a unit area.

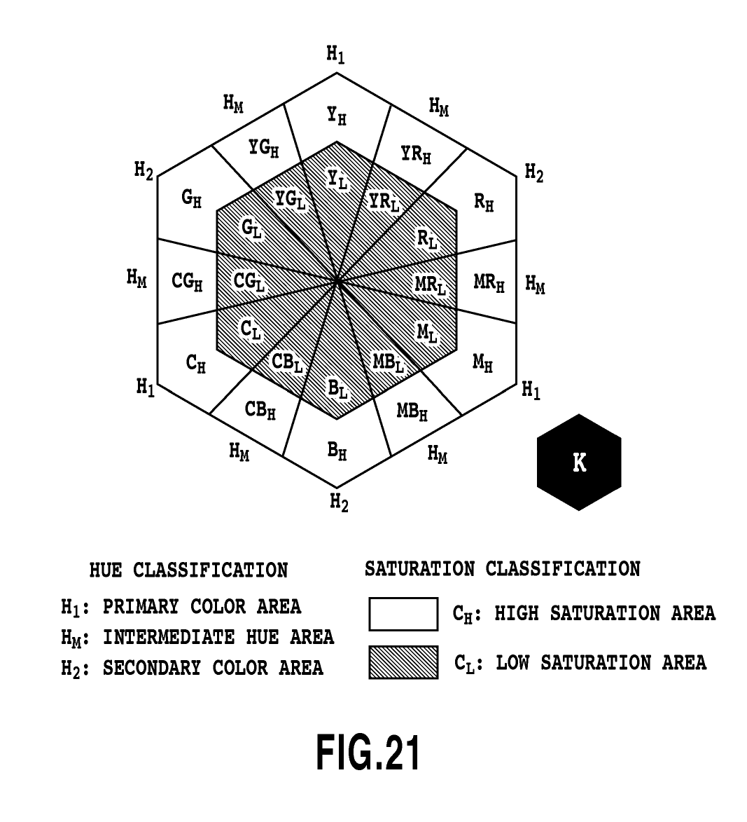

FIG. 21 is an image diagram explaining a color area. In the figure,

H₁, H_{M}, and H₂ indicate the hue in the primary color area, secondary color area and intermediate hue area. The areas filled in with gray, are low saturation areas, and other areas are high saturation areas. Only K is classified separately. For example, when data included in a processed area is nearly all Y data and hardly any other ink data is included, the color is determined to be Y_{H}. Moreover, when most of the data included in a processed area is Y data, and M and C data are included in equal amounts, the color is determined to be Y_{L}. In other words, by performing color determination, which inks and at what percentages the inks are contained in each processed area is known.

Next, the method of selecting a processing liquid generation mask in step S107 in FIG. 10 will be explained.

Table 4 is a table for explaining a processing liquid mask table. The table illustrates the relationship between the scanning direction and the processing liquid generation mask that is selected according to D_{K+CL} (total duty) when the color is determined to be R_{H}.

TABLE 4
R_{H} Processing Liquid Generation Mask

| D_{K+CL} | Printing order 1 | Printing order 2 |
|---|---|---|
| 0% to 50% | A | B |
| 50% to 100% | C | D |
| 100% to 150% | E | F |
| 150% to 200% | G | H |
| Greater than 200% | I | J |

For example, when the color is determined to be R_{H} in the color determination process (S106), then in step S107, the R_{H} processing liquid generation mask table illustrated in Table 4 is referenced. Step S107 is a method for determining the amount of processing liquid. In order to simplify the explanation, only R_{H} is listed in Table 4; however, there are similar tables for the other colors as well. Next, when the printing order of the processed area is printing order 1, and the value of D_{K+CL} is between 50% and 100%, processing liquid generation mask C is selected. In another example, when the printing order is printing order 2 and the value of D_{K+CL} is between 150% and 200%, processing liquid generation mask H is selected. The size of the processing liquid generation mask is the same as the processed area, 16×16 (300 dpi). Moreover, at least one of the processing liquid generation masks A to J is different mask data. The reason for making the selected mask data different according to the value of D_{K+CL} as well is that, even for colors having the same hue, when the total amount of ink that is applied differs, the optimum amount of processing liquid differs. By changing the mask selected according to the value of D_{K+CL} it is possible to control the amount of processing liquid applied such that it is the optimum amount.

Next, the method for generating processing liquid data in step S108 in FIG. 10 will be explained. Processing liquid data is generated from the inputted K, C, M and Y data and the processing liquid generation mask that was selected in step S107.

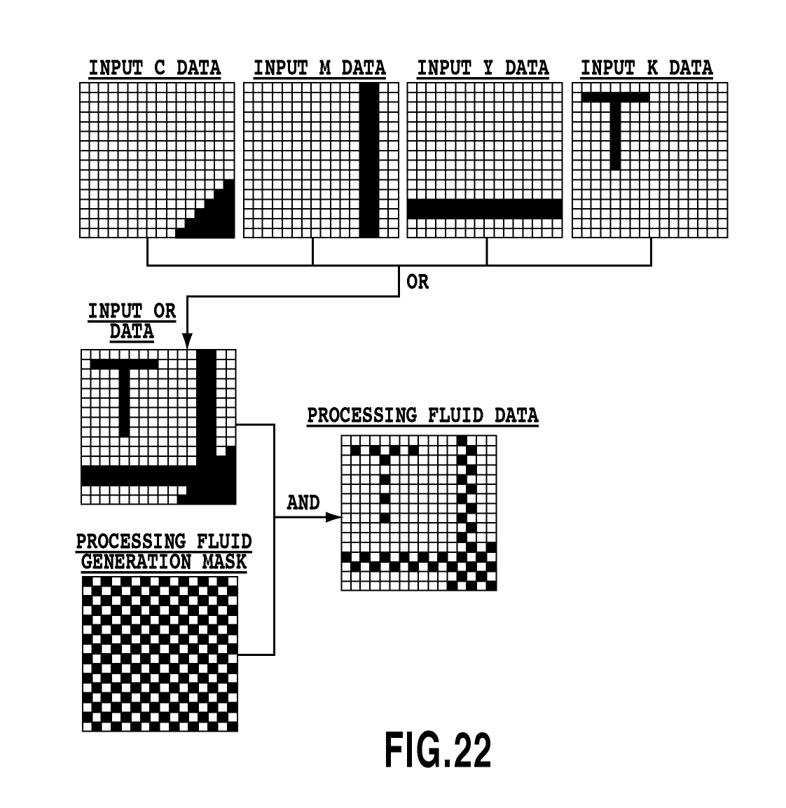

FIG. 22 is a schematic diagram for explaining the processing liquid data generation method. First, the logical sum (OR) of the inputted data K, C, M and Y is taken to generate input OR data. Here, the size of the inputted data K, C, M and Y and the input OR data is the same as the size of the processed area, 16×16 (300 dpi). Next, the logical product (AND) of the input OR data and the processing liquid generation mask that was selected in step S107 is taken to generate processing liquid data. The processing liquid generation mask illustrated in FIG. 22 corresponds to a 50% printing duty. By taking the AND with the input OR data, data that is reduced by the 50% duty is generated. By selecting a processing liquid generation mask and generating processing liquid data that provides the optimum amount of processing liquid in this way, it become possible to arbitrarily control the printing duty of the processing liquid.

The explanation above is related to the processing liquid data generation process of this embodiment.

In this embodiment, the processing liquid data generation process 1006 is performed based on binary KCMY data 1005. However, the data does not necessarily need to be binary data, and the processing liquid data can be generated based on multi-value data. In this case as well, the total amount of a plurality of colors of ink that are printed in a unit area, and the ratios of the amounts of each ink color can be acquired based on multi-value data, and the amount of processing liquid determined. Moreover, generation of processing liquid data is performed by the main printer unit 1210; however, of course the data can be generated by the host PC or the like. Any construction is possible as long as it is possible to perform color determination according to the total amount that each ink is applied and the ratios of each ink color in an image, and to determine the amount of processing liquid.

Moreover, in this embodiment, the case of using four colors, black, cyan, magenta and yellow, was explained. However, in the case where additional colors such as gray ink like photo cyan and photo magenta, and red, blue and green ink are used, the amount of processing liquid for forward and backward scanning should be determined in the same way according to there relative percentage and the total printed amount of each ink in an image.

Furthermore, this embodiment is a method of separately generating the amount of processing liquid for forward scanning and backward scanning in a form of performing printing by using forward and backward scanning; however, as long as the method determines the amount of processing liquid according to information that indicates the color of an image to be printed, the invention is not limited to a form of printing using forward and backward scanning.

This embodiment performs color determination of an image to be printed in a unit area based on the dot count value obtained from counting the number of ink droplets printed in a unit area; however, in the case of a size of a plurality of ink droplets, the invention is not limited to this form. In other words, the hue of an image to be printed is set according to the total amount of ink applied to a unit area and the percentages of each color, and when the size is the size of a plurality of ink droplets, the color may differ even though the number of ink droplets applied is the same. Therefore, the color can be determined and the amount of processing liquid can be set based on the amount of ink applied to the unit area and the relative percentage of each color.

Moreover, this embodiment is constructed so that color unevenness can be reduced when different colors are printed in forward scanning and backward scanning; however, depending on the colors, color unevenness may hardly occur at all in forward and backward scanning. For example, when one of the colors Y_{H}, C_{H} and M_{H}, is determined in the color determination process (S106) to be the primary color area, color unevenness hardly occurs at all in forward and backward scanning. This is because, most of the ink that is applied in this primary color area is one color of ink, and the amount of other ink applied is zero or a very small amount. Therefore, in these areas where hardly any color unevenness occurs due to printing order, it is not necessary to change the amount of processing liquid applied in forward scanning and backward scanning. In other words, the amount of processing liquid applied is essentially the same amount, so there is no need to store masks for forward scanning and backward scanning.

Furthermore, in this embodiment, changing the amount of processing liquid according to the printing order means that the position where the ink is fixed on the printing medium is controlled. In this specification, the processing liquid is a liquid such that when ink comes in contact with the liquid the coloring material in ink is not dissolved, or is a liquid containing a component that causes the coloring material in the ink to precipitate out; however, the processing liquid can also be a liquid containing a component that promotes the permeation of ink. The processing liquid could also be a liquid containing a component that causes the position where the ink is fixed on the printing medium to change. Moreover, in this embodiment, a form is used where processing liquid is applied before ink; however, the invention is not limited to this, and a form is possible in which processing liquid is applied after the ink.

### Embodiment 2

In the first embodiment, in the method of determining the amount of processing liquid to apply during forward and backward scanning, a method of selecting a combination that minimizes the color difference ΔE was explained. In this second embodiment, a method of selecting a combination that minimizes the difference in hue is explained. The construction except for the method of determining the amount of processing liquid to apply is the same as in the first embodiment.

An example of the case of printing red using a combination of magenta having a duty of 50% and yellow having a duty of 50% duty in both forward and backward scanning is explained. Table 2 was explained in the first embodiment, and is a table illustrating the relationship between the amount of processing liquid applied in each printing order and the color measurement values when the color of the printed matter is measured using a colorimeter.

In this second embodiment, the color difference DE_{H} is calculated for all combinations of the color measurement values of the printed matter in printing order 1, and the color measurement values of the printed matter in printing order 2 except for L*. The reason for using the color difference except for the brightness L* is that there are cases when color unevenness appears more remarkable when the hue differs than when the brightness differs. ΔE_{H} is calculated using the following equation for an example in which the amount of processing liquid applied in printing order 1 is 20% and the amount of processing liquid applied in printing order 2 is 20%.

ΔE_{H}={(a*2−a*5)²+(b*2−b*5)²}^{1/2} [Equation 1]

Then, a combination having the minimum value among the ΔE_{H} calculated in the same way as the first embodiment is selected, and the amount of processing liquid to be applied during forward and backward scanning is determined. In other words, the optimum amount of processing liquid to be applied for each printing order is correlated with the color difference between the first image and the second image.

In this embodiment, the amount of processing liquid to apply is determined by selecting a combination that minimizes the hue difference. However, when it is necessary to apply a fixed amount or more of processing liquid in order to obtain a certain density, it is possible to select a combination from among combinations of a fixed amount or more of processing liquid that reduces the difference in hue.

### Embodiment 3

In this embodiment, the processing liquid data generation process for different kinds of media is explained. The other construction is the same as in the first embodiment. Permeation of ink and the fixed state of ink changes depending on the kind of printing medium. As a result, even though color unevenness does not occur in forward and backward scanning for an applied amount of processing liquid for a certain printing medium α, color unevenness will occur for a different printing medium β. In other words, it is necessary to change the amount of processing liquid applied according to the kind of printing medium.

In this embodiment, construction is explained in which a processing liquid generation mask table used in the processing liquid data generation process is provided for each medium type, and by generating processing liquid data, it is possible to reduce color unevenness even though the medium differs.

Here, a method of selecting a processing liquid generation mask in step S107 in FIG. 10 is explained. Table 5 is a table for explaining the processing liquid mask table. The table illustrates the relationship between the scanning direction and the processing liquid generation mask that is selected according to D_{K+CL} (total duty) in the case where the color is determined to be R_{H}.

TABLE 5
R_{H} Processing Liquid Generation Mask Table

| | | |
|---|---|---|
| D_{K+CL} | Printing order 1 | Printing order 2 |

(a) Medium α

| | | |
|---|---|---|
| 0% to 50% | A | B |
| 50% to 100% | C | D |
| 100% to 150% | E | F |
| 150% to 200% | G | H |
| Greater than 200% | I | J |

(b) Medium β

| | | |
|---|---|---|
| 0% to 50% | K | P |
| 50% to 100% | L | Q |
| 100% to 150% | M | R |
| 150% to 200% | N | S |
| Greater than 200% | O | T |

For example, when the color is determined to be R_{H} in the color determination process (S106), the R_{H} processing liquid generation mask table illustrated in Table 5 is referenced in step S107. When doing this, in the case where the type of printing medium is medium α, Table 5 (a) is referenced, and in the case where the type of printing medium is medium p, Table 5(b) is referenced.

For example, for medium type α, when the printing order is printing order 1 and the value of D_{K+CL} is between 50% and 100%, processing liquid generation mask C is selected. On the other hand, when the printing order and value of D_{K+CL} are exactly the same, and the printing medium type is β, processing liquid generation mask L is selected. In this way, there is a table for each medium type, and by changing the mask that is selected, it is possible to reduce color unevenness even when the type of printing medium is different.

### Embodiment 4

In the first embodiment, an example of using 1-pass printing to complete the printing of a head width portion in one printing scan was explained. In this embodiment, the processing liquid data generation process in the case of using multi-pass printing to complete printing in a plurality of printing scans is explained. The other construction is the same as in the first embodiment.

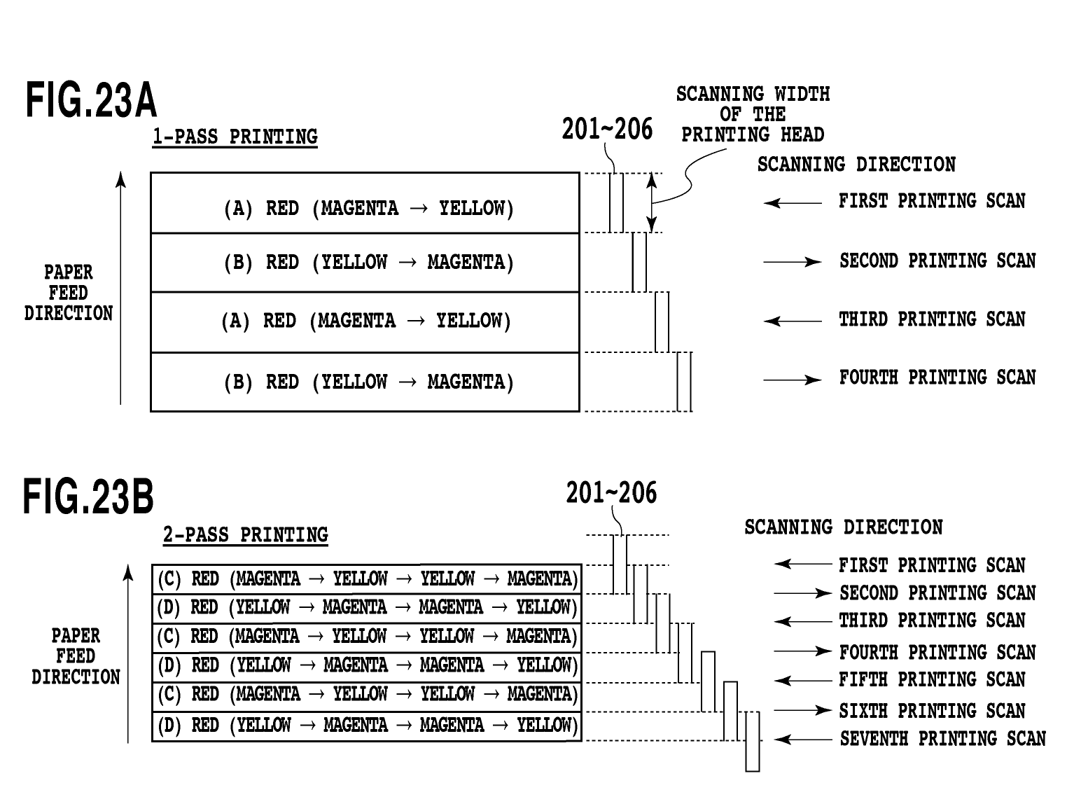

FIG. 23A is a diagram explaining 1-pass bi-directional printing of a red image. As was explained in the first embodiment, the printing order of magenta ink and yellow ink differs in forward scanning and backward scanning by the printing head (in forward scanning the order is (A) magenta→yellow, and in backward scanning the order is (B) yellow→magenta), so color unevenness occurs for each scanning width by the printing head. In the case of 1-pass printing, it is possible to reduce the color unevenness during bi-directional printing by changing the amount of processing liquid applied for each area (A) and (B).

FIG. 23B is a diagram explaining 2-pass bi-directional printing of a red image. In 2-pass printing, first, the nozzles of the lower half of the printing head are used in the first print scan, and printing of an image is performed having a duty of approximately 50% in the printing order magenta→yellow. Next, the paper is fed half the width of the head, and using the upper half of the head, printing having a duty of approximately 50% is performed in the printing order yellow→magenta to complete the image. The entire image is printed by alternately repeating this. The printing order of magenta ink and yellow ink differs in forward scanning and backward scanning of the printing head, so color unevenness occurs every half width of the printing head. As illustrated in FIG. 23B, color unevenness occurs in each area (C) that is printed in the printing order magenta→yellow→yellow→magenta, and each area (D) that is printed in the printing order yellow→magenta→magenta→yellow. In the case of 2-pass printing, by changing the amount of processing liquid that is applied to each area (C) and (D), it is possible to reduce color unevenness during bi-directional printing.

In this embodiment, construction is explained in which a processing liquid generation mask table that is used in the processing liquid data generation process is provided for each number of printing passes, and by generating processing liquid data, it is possible to reduce color unevenness even when the number of printing passes differs.

Here, a method for selecting the processing liquid generation mask in step S107 in FIG. 10 is explained. Table 6 is a table illustrating the relationship between the scanning direction and the processing liquid generation mask that is selected according to D_{K+CL} (total duty) when the color is determined to be R_{H}.

TABLE 6
R_{H} Processing Liquid Generation Mask Table
(a) 1-Pass Printing

| D_{K+CL} | Printing order A | Printing order B |
|---|---|---|
| 0% to 50% | A1 | B1 |
| 50% to 100% | C1 | D1 |
| 100% to 150% | E1 | F1 |
| 150% to 200% | G1 | H1 |
| Greater than 200% | I1 | J1 |

(b) 2-Pass Printing

| D_{K+CL} | Printing order C | Printing order D |
|---|---|---|
| 0% to 50% | A2 | B2 |
| 50% to 100% | C2 | D2 |
| 100% to 150% | E2 | F2 |
| 150% to 200% | G2 | H2 |
| Greater than 200% | I2 | J2 |

For example, when the color is determined to be R_{H} in the color determination process (S106), the RH processing liquid generation mask table illustrated in Table 6 is referenced in step S107. When doing this, when the number of printing passes is 1-pass printing, Table 6(a) is referenced, and when the number is 2-pass printing, Table 6 (b) is referenced. In other words, the amount of processing liquid is determined according to the number of scans needed to complete each image.

For example, in the case of 2-pass printing, when the printing order for the processed area is C, and the value of D_{K+CL} is between 50% and 100%, processing liquid generation mask C2 is selected. In this way, there is a table for each number of printing passes, and by changing the mask selected, it is possible to reduce color unevenness even when the number of printing passes differs.

In this embodiment, the case of 1-pass printing and 2-pass printing was explained; however, construction can also be such that in the case of multi-pass printing such as 4-pass printing, 8-pass printing and the like, processing liquid data is similarly generated for each area having a different printing order.

### Other Embodiments

In the embodiments above, methods where given where mask tables for determining the amount of processing liquid to apply were stored in the ROM 402 of the inkjet printer; however, the present invention is not limited to this. The mask tables could be stored in the RAM 403. Furthermore, the process described above for determining the amount of processing liquid to apply can be performed by the printer driver of the host PC instead of by the inkjet printer. Preferably, when the dot count of the printing data is performed by the host PC, the process for converting the multi-value image data to be printed to binary image data is performed by the host PC.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2010-188431, filed Aug. 25, 2010, and 2011-163162, filed Jul. 26, 2011, which are hereby incorporated by reference herein in their entirety.

What is claimed is:

1. An image processing apparatus that generates printing data for printing an image in a unit area on a printing medium by causing a printing unit to scan the printing medium, the printing unit being capable of applying a plurality of colors of ink and a processing liquid by ejecting the ink and the processing liquid, the processing liquid reacting with the ink, comprising:
an acquisition unit that acquires the total number of ink droplets of the plurality of colors of ink to be applied to the unit area and a ratio between the numbers of ink droplets of the plurality of colors of ink to be applied to the unit area from image data to be printed in the unit area; and
a setting unit that sets an amount of processing liquid to be applied to the unit area based on both the total number and ratio.

2. The image processing apparatus according to claim 1, wherein
the printing unit is capable of printing an image on a printing medium by scanning in a forward direction and in a backward direction; and
the setting unit sets an amount of processing liquid to be applied to the unit area based on the total number, ratio acquired from the acquisition unit and information of a scanning direction with respect to the unit area.

3. The image processing apparatus according to claim 1, wherein
the printing unit prints an image in the unit area in a single scan by the printing unit.

4. The image processing apparatus according to claim 2, further comprising
a storage unit that stores a table associating the total number and ratio with the amount of processing liquid to be applied to the unit area for each scanning direction with respect to the unit area; wherein
the setting unit sets the amount of processing liquid to be applied to the unit area based on the table.

5. The image processing apparatus according to claim 1, wherein
the printing unit applies the processing liquid with respect to the unit area before applying the plurality of colors of ink.

6. The image processing apparatus according to claim 2, wherein
the setting unit sets the amount of processing liquid to be applied to substantially the same amount for scanning the unit area in any scanning direction, in case where the total number and ratio acquired by the acquisition unit are predetermined values, respectively.

7. The image processing apparatus according to claim 2, wherein the setting unit sets the amount of processing liquid to be applied to the unit area when the scanning direction of the printing unit with respect to the unit area is the forward direction different from the amount of processing liquid to be applied to the unit area when the scanning direction of the printing unit with respect to the unit area is the backward direction.

8. The image processing apparatus according to claim 1, wherein the processing liquid insolubilizes or coagulates the coloring material in the ink.

9. The image processing apparatus according to claim 1, wherein the setting unit sets the amount of processing liquid to be applied further depending on the type of printing medium.

10. A printer comprising:
the image processing apparatus; and
the printing unit according to claim 1.

11. An image processing method having generating printing data for printing an image in a unit area on a printing medium by causing a printing unit to scan the printing medium, the printing unit being capable of applying a plurality of colors of ink and a processing liquid by ejecting the ink and the processing liquid, the processing liquid reacting with the ink, comprising:
acquiring the total number of ink droplets of the plurality of colors of ink to be applied to the unit area and a ratio between the numbers of ink droplets of the plurality of colors of ink to be applied to the unit area from image data to be printed in the unit area; and
setting an amount of processing liquid to apply to the unit area based on both the total number and ratio.

12. An image processing apparatus that generates printing data for printing an image in a unit area on a printing medium by causing a printing unit to scan the printing medium, the printing unit being capable of applying a plurality of colors of ink and a processing liquid by ejecting the ink and the processing liquid, the processing liquid reacting with the ink, comprising:
an acquisition unit that acquires a total amount of the plurality of colors of ink to be applied to the unit area and a ratio between the amounts of the plurality of colors of ink to be applied to the unit area from on image data to be printed in the unit area; and
a setting unit that sets an amount of processing liquid to be applied to the unit area based on both the total amount and ratio acquired by the acquisition unit.
